(19) United States
(12) Patent Application Publication
(10) Pub. No.: US 2015/0363887 A1
(43) Pub. Date: Dec. 17, 2015

(54) SYSTEM FOR TRACKING AND ATTRIBUTING CREDIT ACCRUED THROUGH GEOGRAPHICALLY DISPERSED REPRESENTATION

(71) Applicants: Joe Ferri, Long Valley, NJ (US); Alison Cody, Atlanta, GA (US)

(72) Inventors: Joe Ferri, Long Valley, NJ (US); Alison Cody, Atlanta, GA (US)

(21) Appl. No.: 14/302,299

(22) Filed: Jun. 11, 2014

(51) Int. Cl. G06Q 40/00; G06Q 30/06

(52) U.S. Cl. CPC G06Q 40/12; G06Q 30/0617

(57) ABSTRACT

A computer based networked system and corresponding method for associating attributes of a specification with participants in the performance of the specification requirements and tracking, crediting and reporting geographically dispersed contributions.

### TECHNICAL FIELD

The present disclosure relates to systems and methods to track and attribute sales and marketing representative contributions in connection with dispersed activities.

### BACKGROUND

Many industries rely on a sales force to bring their products to market. In some industries, the sales force is localized. In others, the sales force may be spread across a country, continent or the globe. Many enterprises hire their own sales representatives as employees. Sales representatives are compensated largely at least in part on a commission basis (i.e., a percentage of sales in dollars of the enterprise's product attributable to the sales representative). Large companies may have the luxury of hiring their own sales personnel as employees. This comes with the cost of providing such employees with salary and benefits, such as health care and retirement plans, office space, and support personnel. In exchange for permanent employment, the sales representative represents only the employer.

Many companies, however, are not in a position to hire a full or even part time sales force. Instead, these companies retain independent sales representatives (ISR). An ISR acts as an agent for the company and often as the company's interface with retailers or other users or sellers of a company's product. One difference between the ISR and the employee sales representative is that while the employee will represent only their employer, the ISR may serve as a sales representative for other entities, although the ISR may be contractually prohibited from representing competitors of the company.

An important consideration for an individual choosing a career as an ISR is compensation for services rendered. Typically, the ISR is not a salaried employee but is compensated on a commission basis. For sales of affiliated manufacturer products by an ISR, the calculation of compensation owed the ISR seems straightforward. Difficulties arise, however, when an ISR plays an indirect or geographically remote role in the manufacturer's sale of a product. This often occurs in the context of an effort to construct a new foodservice facility that involves nationwide participation by various individuals and entities involved in the construction process. In those circumstances, a remotely located ISR's valuable input and services in connection with the operation's success and sale of the associated manufacturer's product are often difficult to account for and quantify, resulting in the ISR not being compensated for services rendered.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a relational diagram of participants in the sale, product distribution and facility construction process of the present disclosure.

FIG. 2 is a network diagram of an embodiment of the present disclosure.

FIG. 3 is a flow diagram of a member enrollment process in accordance with an embodiment of the present disclosure.

FIG. 4 is a flow diagram of a member delivery and platform processing of a specification in accordance with an embodiment of the present disclosure.

FIG. 5 is a flow diagram of manufacturer profile creation in accordance with an embodiment of the present disclosure.

FIG. 6 is a flow diagram of member representative attribution report generation in accordance with an embodiment of the present disclosure.

FIG. 7 is a flow diagram of the specification tracking system in accordance with an embodiment of the present disclosure.

FIG. 8 is a flow diagram of a credit allocation process in accordance with an embodiment of the present disclosure.

### DETAILED DESCRIPTION OF THE EMBODIMENTS

Before undertaking the detailed description below, it may be advantageous to set forth definitions of certain words and phrases used in connection to the disclosed exemplary embodiments: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although the subject matter of this application has been described with reference to illustrative embodiments, this description is not intended to be construed in a limiting sense. Various modifications and combinations of the illustrative embodiments as well as other embodiments will be apparent to persons skilled in the art upon reference to the description. It is, therefore, intended that the appended claims encompass any such modifications or embodiments. This general processes and systems described herein may be modified heavily depending on a number of factors, with rearrangement and/or addition/deletion of steps anticipated by the scope of the present disclosure. Integration of this and other preferred exemplary embodiment methods in conjunction with a variety of preferred exemplary embodiment systems described herein is anticipated by the overall scope of the presently disclosed system.

In large scale food preparation and service operations, equipping space for such operations is a highly complex and regulated endeavor. With seemingly endless sources to choose from to equip a food service and preparation facility, the process of procuring equipment and contracting services to handle the build out, installation and maintenance of the facility lends itself to a competitive bidding process. In a competitive bidding process, various sources of products or services submit bids to the party in need of the products or services and based on a variety of factors including price of goods and services offered as well as experience of the provider, the party in need awards the job to a single or multiple bidders.

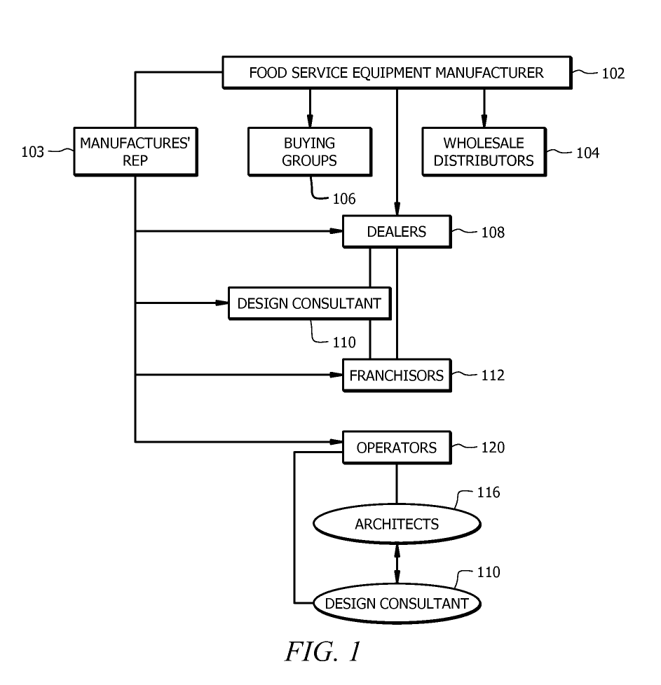

The relationships and interfacing of parties or entities involved in the foodservice equipment manufacturing process is depicted in FIG. 1. FIG. 1 shows the interaction and flow of goods between various players in the manufacturing, distribution and sales layers of a product. In the foodservice industry a product may be a simple and inexpensive as a common kitchen spatula or as complex and costly as an industrial walk-in refrigeration unit. FIG. 1 depicts the various layers of the distribution chain of a product as it passes from a foodservice equipment manufacturer (FEM) 102 to the ultimate user of the equipment called the operator 120, which may be any foodservice provider such as a restaurant, hospital, contract feeder, school or the like. As seen in FIG. 1, FEM 102 gets its equipment to market in a variety of ways. It may supply its products to buying groups 106, which offer downstream buyers lower pricing based on an anticipated high volume of sales. FEMs 102 may also get their products to market by supplying product to wholesale distributors 104. These wholesale distributors 104 may or may not be exclusive product distributors of an FEM.

FEMs 102 may also supply products to Dealers 108, which also serve as intermediate suppliers of products to operators 120. Also, FEMs 102 may supply products directly to an operator 120.

There are also parties that perform various roles between Dealers 108 and Operators 120, such as Design Consultants 110 and Franchisors 112. Design consultants 110 provide operators 120 with guidance on various issues such as aesthetics, functionality and ergonomics of the operator's foodservice setting. In settings in which the operator's operation is a franchise of, for example, a national restaurant chain, the franchisor 112 will interact with equipment dealers 108 and operators 120 to ensure that the facility under construction complies with the franchisor's 112 requirements.

FEM 102 typically have representatives 103 that interface with the aforementioned entities that comprise the product distribution paradigm of FIG. 1. Representatives 103 may be independent representatives who may serve only a particular manufacturer or multiple manufacturers. Alternatively, representatives 103 may be employees of FEM 102 and represent only an employer FEM. Either way, representative 103 may interact with dealer 108, design consultants 110, franchisors 112 and directly with operators 120 during the process of supplying FEM equipment to an operator and during the installation process of such equipment at the operator's site.

As seen in FIG. 1, the process of getting an FEM's product into the hands of an operator and installed can involve numerous parties with different responsibilities, interests and compensation scenarios. The process of FIG. 1 also depicts the interaction among parties for one FEM's offerings. In practice, when an operator 120 such as the operator of a new location of a national restaurant chain needs to fully outfit a restaurant, products from potentially hundreds of FEMs will be purchased to equip that restaurant. Thus, there may be hundreds of relationships depicted in FIG. 1 operating in parallel as a new restaurant construction project ensues. A common concern is that the products of one FEM may interface with the product of another FEM and certain product specifications of the product of one FEM will be relied upon by the FEM of another product. Product delivery time is also critical as construction of a foodservice site is often performed in stages where installation of one item is conditioned upon installation of another. For example, installation of a disposal beneath a utility sink is premised on pre-installation of the sink and necessary electrical access for the disposal.

Another aspect of the construction process is specification integrity. When bids for equipment are solicited, the winning party typically offers very specific identification of the equipment to be provided for the site. Often this is the product of the request for proposal submitted by the operator and/or design consultant 110. In one context, dealers 108 will submit bids for a component of equipment needed for the project. This bid usually is tied to a specific unit type associated with a unique product part number, model number or SKU pertaining to a specific product of a specific manufacturer. Once the competitive bidding process runs its course and contracts are awarded to various dealers 108, there may be a departure from the specific items identified in the RFP or in the submission by the winning dealer bidder in the form of substituting identified products. This is caused by a variety of factors, such as product availability and price. Unfortunately, by the time a particular product arrives at the operator site, it is long after the competitive process is complete and at a time where construction schedules are extremely compressed and pressure on the general contractor in charge of the project to complete on schedule is immense. Accordingly, there is little available to help in determining who in the distribution channels authorized substitution of the specified product and when the decision was made.

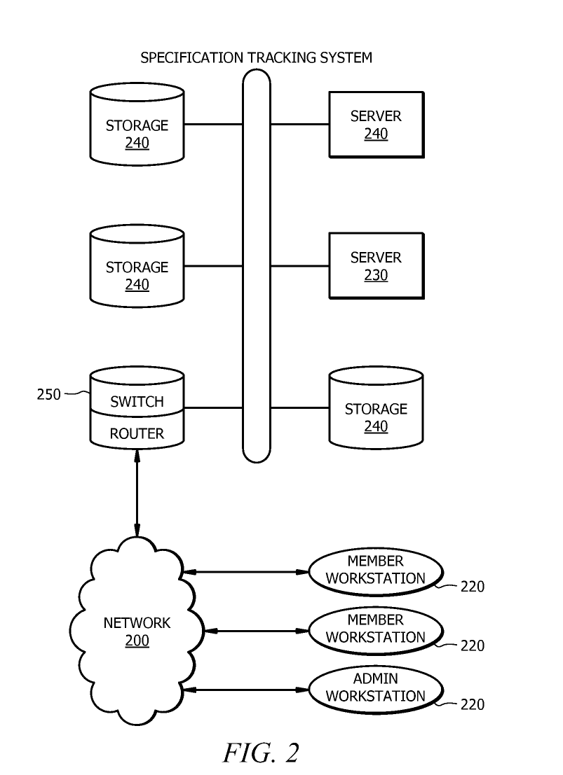

The embodiments of the present disclosure provide an equipment specification tracking platform in which awarded contracts for operator site construction and representative contribution and participation are efficiently tracked. The platform is represented by a system depicted in FIG. 2. Various embodiments of the disclosed specification tracking system may operate in a wide area network environment, such as the Internet, including multiple network addressable systems. FIG. 2 depicts an example network environment, in which the various disclosed embodiments may operate. Network cloud 200 may include one or more interconnected networks, over which the systems and hosts disclosed can communicate. Network cloud 200 may include packet-based wide area networks (such as the Internet), private networks, wireless networks, satellite networks, cellular networks, and the like. In connection with the disclosed embodiments, as FIG. 2 depicts particular embodiments may operate in a network environment comprising a specification tracking system 210 and one or multiple user workstations 220. The various servers, software and functionality described herein may reside in a single dedicated system as shown or may be operable via separate systems. For example, the representative enrollment functionality described herein may reside in a single system as shown or may be operable as separate subsystem that may communicate with other subsystems via network 200. For simplicity, however, these subsystems and various functions will be depicted as residing in a single system.

User workstations 220 are operably connected to the network environment via a network service provider, a wireless carrier, or any other suitable means. User workstation 220 is generally a computer or computing device including functionality for communicating (e.g., remotely) over a computer network. User workstation 220 may be a desktop computer, laptop computer, personal digital assistant (PDA), smart phone or other cellular or mobile phone, among other suitable computing devices.

In one example embodiment, specification tracking system 210 includes computing systems permitting users to communicate or otherwise interact with the specification tracking system 201 other workstations 220 and access content, such as a status reports, credit attribution reports and updated subscriber or member information or other content. Specification tracking system 210 is a network addressable system that, in various example embodiments, comprises one or more servers 230 and storage devices 240. The single or multiple servers 230 are operably connected to computer network 200 via, by way of example, a set of routers and/or networking switches 250. In one embodiment, the functionality hosted by the one or more servers 230 may include web or HTTP servers, FTP servers, as well as, without limitation, web pages and applications implemented using Common Gateway Interface (CGI) script, Active Server Pages (ASP), all versions of Hyper Text Markup Language (HTML), Extensible Markup Language (XML), Java, JavaScript, Flash, ActionScript, Asynchronous JavaScript and XML (AJAX), and the like.

Servers 230 may host functionality directed to the operations of specification tracking system 210. In one embodiment, specification tracking system 210 may host a website that allows one or more subscribers, at one or more workstations 220, to access specification tracking system generated reports and obtain specification status updates as well as communicate and interact with one another via the website. Similarly, administrators may access specification tracking system 210 remotely via workstations 220 to update manufacturer information, representative attribute related data or contract award status. Servers 230 may be a single server or multiple server hosting specification network system 210, as well as other content distribution servers, storage devices 240, and databases.

Storage device 240 may store content and data relating to, and enabling, operation of the specification tracking system 210 as digital data objects. A data object, in particular implementations, is an item of digital data stored or embodied in a data file, database or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Storage device 240 corresponds to one or more of a variety of separate and integrated databases, such as relational databases and object-oriented databases that maintain information as an integrated collection of logically related records or files stored on one or more physical systems. Storage device 240 may include one or more of a large class of data storage and management systems. Storage device 240 may be implemented by any suitable devices including one or more database servers, mass storage media, media library systems, storage area networks, data storage clouds, and the like. Storage device 240 may include one or more servers, databases (e.g., MySQL), and/or data warehouses.

Storage device 240 may include data associated with different specification tracking systems 210 users or workstations 230. In particular embodiments, the specification tracking system 210 maintains a member profile for each user of the system 210. Member profiles include data that describe the users of a network, which may include proper names (first, middle and last of a person, a trade name and/or company name of a business entity, etc.), biographic, demographic, and other types of descriptive information, such as manufacturer affiliation, geographic location, and other pertinent data. Specification tracking system 210 may contain data describing relationships between members, including other representatives, equipment manufacturers, designers, and dealers. The information may indicate a member's association with a particular geographic location and representative activities associated with that location. A member profile may also include privacy settings governing access to the member's information and limiting member access to information relevant to that member.

Workstation 220 may execute one or more client applications, such as a web browser (e.g., Microsoft Internet Explorer, Mozilla Firefox, Apple Safari, Google Chrome, etc.), to access and view content over a computer network. In some embodiments, workstation applications allow a user of workstation 220 to enter addresses of specific network resources to be retrieved, such as resources hosted by specification tracking system 210. Such addresses are typically Uniform Resource Locators, or URLs. In addition, once a page or other resource has been retrieved, the client applications may provide access to other pages or records via on hyperlinks to other resources.

A webpage or resource embedded within a webpage may itself include multiple embedded resources including data records, such as plain textual information, or more complex digitally encoded multimedia content. A common markup language for creating web pages is the Hypertext Markup Language (HTML). Other common web browser-supported languages and technologies include the Extensible Markup Language (XML), the Extensible Hypertext Markup Language (XTML), JavaScript, Flash, ActionScript, Cascading Style Sheet (CSS), and, frequently, Java. HTML enables development of a structured document by denoting structural semantics for text and links, as well as images, web applications and other objects that can be embedded within the page. During a user session at the client, the web browser interprets and displays the pages and associated resources received or retrieved from the website hosting the page, as well as, potentially, resources from other websites.

When a member using workstation 230 desires to view a particular web page hosted by specification tracking system 210, the user's web browser, or other document creates and sends a request to specification tracking system 210. The request generally includes a URL or other document identifier as well as metadata or other information. The request may include information identifying the member, such as a member ID, and information identifying or characterizing the web browser or operating system running on the workstation 230. The request may also include location information identifying a geographic location of the workstation 230 or a logical network location of the workstation 230. The request may be coded to indicate when the request was transmitted.

Enrollment Process

Functionalities of the present specification tracking system may be implemented in software or hardware or a combination of both. When features are implemented in software, this software may be installed by users via known avenues for downloading software or applications on devices such as laptop computers, tablets or smartphones. Alternatively, application software may be implemented using embedded software running on embedded processors or it may run on a specific operating system. Some or all or combinations of applications and feature sets may also be implemented in hardware or in silicon. Some functionality or feature sets may be implemented in special chip sets and may include one or more or combinations of, for example, application-specific integrated circuits (ASICs), field programmable gate arrays (FPGAs), digital signal processors (DSPs), systems on a chip, firmware, etc.

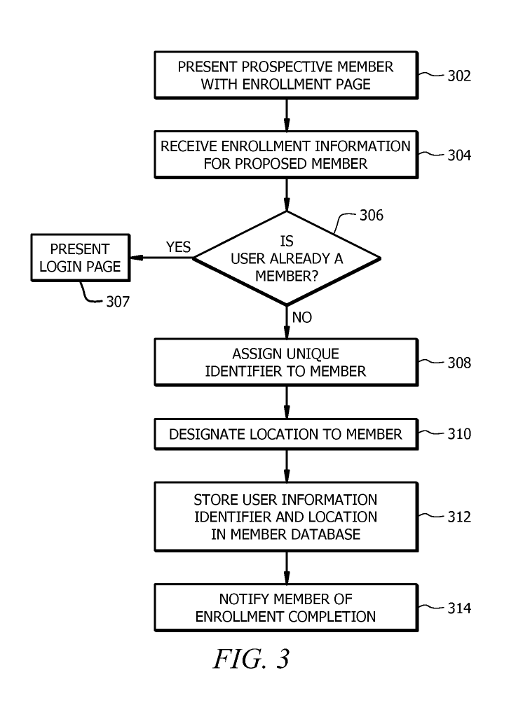

In an embodiment of the present disclosure, a platform is provided through which representatives and manufacturers of products used in the foodservice industry are sold through a bidding process. In one embodiment, manufacturers and manufacturers' representatives enroll as members in and can obtain credentials to interact with the described specification tracking platform. The flowchart of FIG. 3 depicts the steps of a representatives or manufacturers enrollment with the described specification tracking platform. In one embodiment, the specification tracking platform will reside on a cloud based server accessible through a common wide area network such as the Internet that will include a secure user login system accessible. The enrollment process begins with step 302 in which a prospective member accesses the dedicated specification tracking platform (STP) website through an enrollment webpage presented in accordance with a known protocol (HTML, etc.) that provides an interface between the user and STP server and the user is presented with an enrollment page. The process continues with the step 304 of the STP server receiving various user information through the dedicated user interface. Such information includes user name, agency, address, contact information, email address, etc. At step 306, based on information received by the prospective user, such as an email address, physical address or name, the system queries whether this user is already an enrolled member. The prospective user may include a user selected user name and password for accessing the system once enrolled. The STP compares one or more items of user information received by the user at step 304 to information contained in the STP's member database. For example, a user's email address is typically a unique address. If the STP member database contains no such address, then the user may be confirmed as a new enrollee. Other information provided may also be searched in the member database to confirm that the applicant is a new member. If a search of the member database reveals that the user is a previously enrolled user, the user will simply be reminded that she has previously enrolled. If the user is already enrolled, the system proceeds to step 307 and the user is presented with a login page. If the user is not enrolled, the process continues with step 308 where a unique identifier is created for this new member. The identifier may be any alphanumeric combination. This unique identifier will serve to associate a member with various features of the STP system associated with the bidding and credit allocation functionality of the STP system, as will be discussed.

Next, the method proceeds to step 310 where the member is assigned to a location based on geographic information provided, and manufacturer affiliation. This geographic location may be based on a division as broad as a segment of a continent or as granular as neighborhoods of a city depending upon the manufacturer represented by the representative. The information also includes the manufacturers the representative represents.

Next, at step 312, the identifier, location designation and member information is stored in a member database associated with storage device 240. At step 314, the enrollment process concludes with the STP system providing the newly enrolled member with a confirmation message that enrollment is complete. In one embodiment, the user may be presented with a code that is the unique identifier or a series of security questions that may be presented to the user in the event the user wishes to update user information or otherwise access information made available to STP member users.

The enrollment process described above in relation to FIG. 3 may be made available to any participants of the FEM paradigm depicted in FIG. 1. In one embodiment, manufacturers and manufacturers' representatives are the primary enrollees. Some or all of the depicted participants, however, may enroll as members through the described enrollment process.

Bidding Process

Referring back to FIG. 1, when operator 120 decides to construct a foodservice related facility, operator 120 will typically engage an architect 116 and a foodservice design consultant (FSDC) 110. The architect and FSDC work with operator 120 to arrive at a specification for the project. This specification, referred to in the foodservice industry as an 11-4000 specification, among other things identifies the particular equipment and items related to the foodservice aspects of the operation that will be needed to carry out the project. The 11-4000 specification typically includes a comprehensive item-by-item listing of the number of units of a piece of equipment needed, the manufacturer or brand of the equipment, and the model number.

Once the operator 120 with the help of the architect 116 and/or FSDC 110 create a specification for the project, a construction management company or general contractor is hired to manage construction of the foodservice facility. At this juncture, the general contractor typically has a relationship with several dealers 108. The dealers 108 are authorized resellers of the various items of several manufacturers listed as requirements in the 11-4000 specification. The goal of the general contractor is to solicit bids by the dealers on the equipment listed in the 11-4000 specification. Ideally, the fulfillment of the equipment aspect of the project will be awarded to a single dealer. Recall that a dealer 108, however, is a dealer of products of different types manufactured by a number of sources. In order for the dealer 108 to provide the general contractor with pricing information as part of the bid process, dealer 108 calls upon a number of manufacturers' representatives 103 who represent the particular equipment manufacturers. Note that the manufacturers' representatives 103 are responsible for a certain geographic location. Typically, the representatives 103 covers a certain segment of the country or continent. For large manufacturers, depending upon how densely populated a location is, a representative may handle a city, a county, multiple cities or counties, a portion of a state, the entire state, or several states. Regardless of the zone of responsibility of the representative 103, the dealer will call only upon the manufacturer representative assigned to the dealer's location. Accordingly, with respect to the manufacturers' representatives called upon to provide pricing information, those representatives 103 are dedicated manufacturers' representatives located in a particular location that includes the dealer's geographic location.

Once the bidding dealers receive pricing information for various foodservice equipment products from the various manufacturers' representatives, the dealers submit the completed bid for the project to the soliciting general contractor. Based on the information gained through the bid process, the general contractor and the operator, architect and design consultant award the contract to a particular dealer or Kitchen Equipment Contractor, as the dealer will be referred after being awarded the contract.

In one embodiment of the present disclosure, the specification that governs the equipment and services that is to be provided to a particular operator is known in the foodservice industry as an 11-4000 specification.

During the process of the general contractor soliciting bids from the dealers, who in turn seek information from the manufacturer representative, the dealers provide the 11-4000 specification to the manufacturers' representatives. One facet of the disclosed STP system is that it is advantageous for STP system enrolled members, mainly manufacturers' representatives, to submit 11-4000 specifications received from the dealers during the bidding process. The 11-4000 specification is used by the STP system in a variety of ways that is advantageous to the manufacturers' representatives and others involved in the foodservice facility construction process. A part of the manufacturer representative's responsibility is to promote the products of the representative to key players in the facility construction process. This includes promotion of the manufacturer to participants such as dealers, design consultants, operators, franchisors and construction management companies. The relationships between the manufacturers' representatives and these other market participants are vital.

Typically, manufacturers' representatives are compensated on a purely commission basis and is paid by the product manufacturer. That is, the representative's compensation is based on the sales of manufacturer products attributable to the representative's efforts, relationships and sales success. In the foodservice facility bidding and construction paradigm discussed above, the manufacturers' representatives interface with different decision makers in the process. At the dealer level, the manufacturer representative provides the dealer with product pricing information in response to the general contractor's solicitation of bids. At the design stage of the project, the design consultant will interact with various manufacturers' representatives to determine which manufacturer's equipment is best suited for a particular project.

The strength of a representative's relationship with the design consultant is important. Recall that the design consultant provides input in creating the 11-4000 specification. The representative, therefore, adds value to the manufacturer at the design consultant level and should be compensated accordingly. This representative, however, may be a different representative than the representative who interfaces with the dealer, as the dealer and design consultant may be in different geographic locations or simply assigned to different representatives.

A manufacturer representative will also participate at the facility level when the construction project is near completion and the respective manufacturer's equipment is installed. At this juncture, the representative may provide product demonstrations to the operator at the new facility site and will become local contact for manufacturer and provide after sale support. Again, this is often a different representative than the representative who interacts with the dealer and the representative who interacts with the design consultant. It is common that the project, dealer and design consultant are located in three different cities. The concern arises, however, in terms of proper crediting and compensation of all manufacturers' representatives involved in the process. For the representative who interacts with the design consultant and who provides product demonstrations and/or after sale support at the new operation site, the representative's contributions are often overlooked or are not tracked. For the representative, representing many different manufacturers and busy interacting with many customers over a given period, it is burdensome to account for every minute of time or manufacturers' product being sold into and out of their location. Even if the representative reports their activities to the manufacturer (which is responsible for compensating the representative), the manufacturer may disregard the reporting or have difficulty in accurately crediting those representatives involved at each point of interest. Over time, the representatives lose thousands of dollars annually for time lost and manufacturers are administratively burdened and may experience representative attrition due to frustration in the compensation system.

An embodiment of the present specification tracking platform system provides a system for allocating and tracking credits and other information associated with the foodservice operation equipment outfitting process. The STP includes hardware and software configured to effectively receive new project 11-4000 specifications and use information contained therein to track various items of interest.

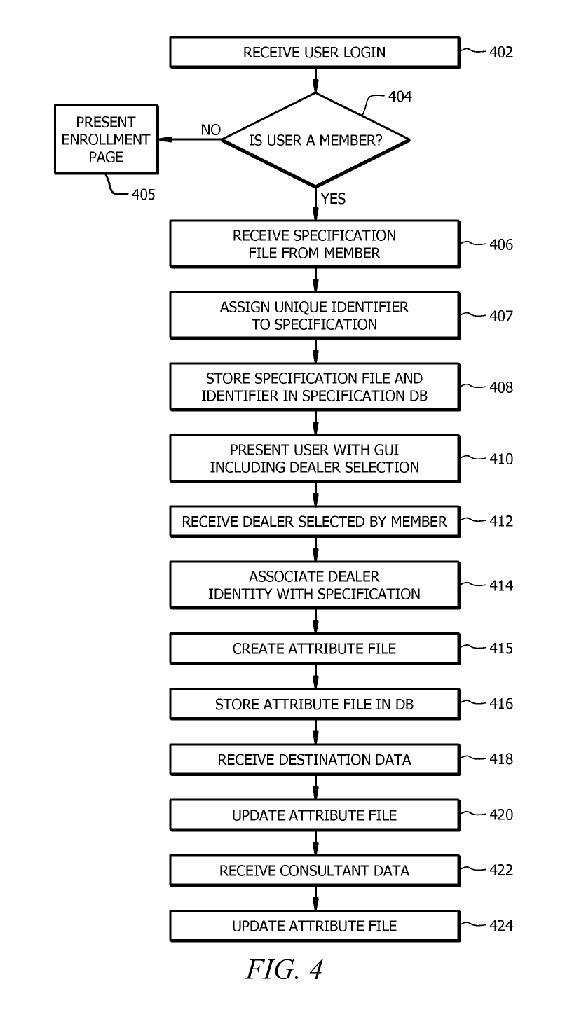

The operation of the present specification tracking platform may be understood with reference to the FIG. 4. In FIG. 4 the process of presenting an 11-4000 specification to the specification tracking platform starts with step 402 in which the STP receives login information from the user. At decision point 404, the STP determines if the user is a member based on the user name and login information. If the user is a member, their login information will be present in the STP member database. If the user is not a member, access to the specification upload process is denied and the user is given the option of registering as a member. If the user is a member and successfully logs in, then the process proceeds to step 406 in which the STP receives an 11-4000 specification file from the user. Optionally, the STP may perform an optical character recognition (OCR) operation on the file to make the file searchable. Alternatively, the 11-4000 may be submitted on a standardized form where data based on field location on the form will be parsed and stored accordingly in the appropriate STP database. The process continues with step 407 where a unique identifier is created and associated with the received specification. At step 408 where the specification and associated identifier are stored in the STP specification database. At step 410, the user is presented with a graphical user interface (GUI) in, for example, an HTML webpage that includes a variety of fields and drop down boxes to populate the various fields. One such field is a Dealer field. The STP system correlates a received 11-4000 specification to the dealer associated with the presenting member. At step 412, the identity of the associated dealer is received from the user. The GUI presented to the user at step 410 includes a drop down box populated with various dealers known to the STP system. If the name of the relevant dealer is shown, the user may simply select it. If the name is not shown, the user may type in the name of the dealer, which becomes a new dealer for the STP system. At step 414, the bidding dealers' identities are associated with the presented specification. At step 415 an attribute file is created for this new specification and the dealer associated with the specification is added to the attribute file. At step 416, the attribute file for the subject specification is stored in an attribute database.

In one embodiment, once the specification is uploaded to the STP system and stored in the specification database as described and the associated attributes file including dealer information is stored in an attributes database the system administrator enters additional attribute information associated with the subject specification. At step 418, the administrator enters and the system receives project destination data. This project destination data may include the project name, project destination/location, project address, and a market segment pertaining to the relevant market of the project, such as country club, hotel or school. The project destination data is entered by the administrator via a HTML webpage, but another suitable form of a GUI known in the art will suffice. Various fields in the webpage form may be filled automatically based on associations between data.

Once the project destination information is completed, the relevant specification file in the attribute data base will be updated to reflect this information and stored at step 420. The process continues with a similar procedure followed by the administrator to add consultant information to the specification attribute file. At step 422, the system receives consultant information entered by the administrator. Such information includes the consultant company/individual's identity, contact information, website and physical address. This specification attribute file is updated to reflect this newly added consultant information and at step 424 the updated attribute file is stored in the attribute database.

As a number of consultants and dealers become known to the system, many of the webpage form fields will be automatically populated upon entry of a single piece of data. For example, subsequent entry of the name of a known consultant will cause automatic population of other related consultant data such as address, contact information, etc.

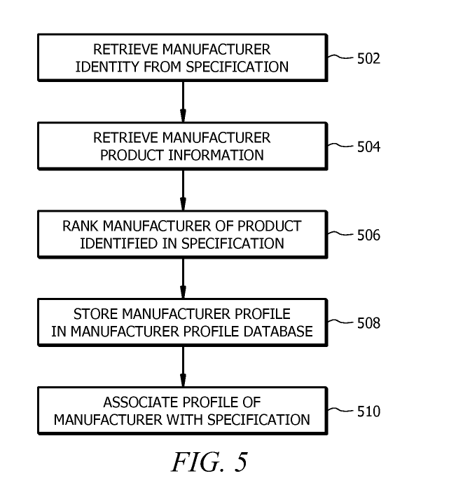

In another embodiment of the present specification tracking platform, the system extracts manufacturer data from a received specification. Continuing with FIG. 5, the system at step 502 retrieves the various manufacturer names from the specification from a universe of some five hundred North American equipment manufacturers using known OCR techniques and known root word expansion techniques to account for variations in spelling.

At step 504 other related manufacturer product information is extracted from the specification, including a model number of associated equipment, a product name, an item number, the quantity of units listed in the specification and a description of the product. Next, at step 506 a rank is assigned by the user or extracted from specification to the manufacturer of a particular product. If a single manufacturer is named in the specification as the source of the item, then that manufacturer is ranked with a designator reflecting the highest rank, such a “prime”. If multiple manufacturers for a particular item are identified, then the user ranks the manufacturers as equal 1, equal 2, equal 3, alt 1, alt 2, etc. At step 508, this manufacturer data is stored as a profile in a manufacturer profile database and at step 510 code or tag the profile to create an association between a particular specification and the manufacturer profile. That is, a product of a particular manufacturer may be found in multiple specifications for different projects. Accordingly, associating a manufacturer and corresponding products to a specification for which bids are solicited is necessary for proper tracking and representative credit allocation, allow manufacturers the ability to better track products in their pipeline to assist with manufacturing schedules and allow manufacturers' representatives to ascertain the market presence in their location or for manufacturers their market presence in totality. In another embodiment of the presently disclosed specification tracking system, an attribute of a dealer/origination entity will be designated at “Awarded” once the contract for the foodservice facility project is awarded to a dealer.

### Representative Credit Allocation

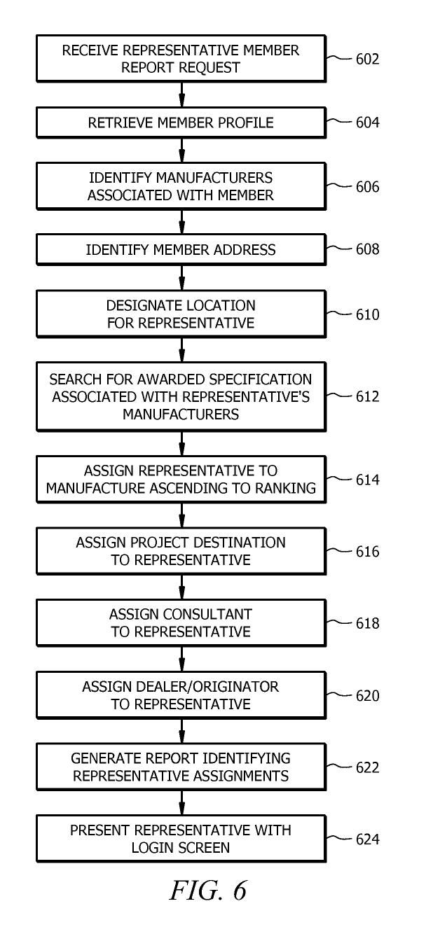

In an embodiment of the present specification tracking platform, enrolled users are typically manufacturers' representatives and manufacturers. In the case of manufacturers' representatives, at enrollment the representative is assigned to a location corresponding to that representative's geographic location and the manufacturer represented. The process performed by the specification tracking platform for generating reports reflecting contract awards attributable to a representative is depicted in FIG. 6. In FIG. 6, at step 602, the report generating process begins with the specification tracking platform system receiving a request from a member use for a new representative report. At this juncture it is assumed that the requesting member is a representative enrolled and active as a subscriber to the platform. At step 604 in response to the report request, the user's profile is retrieved from the member database. At step 606, the previously designated manufacturers associated with the representative are identified. At step 608, the representative's address is identified. This address was provided by the manufacturers' representatives at the time of enrollment. Based on this address information, at step 610 a location is assigned to the representative for each manufacturer associated with the representative. These locations are pre-established for each manufacturer but may be changed over time by the system administrator or user with changing conditions. Once the locations for a representative are established, the process proceeds to step 612 where a search is performed for specifications and/or awarded contracts in which a representative's manufacturer is included as an equipment provider. Next, at step 614 and assignment of representatives to a particular manufacturer cited in a specification according to the ranking of that manufacturer for that specification. At step 616, the representative is assigned to a project destination in the representative's location, if any, for each specification attributable to that representative's manufacturer. Next, at step 618 a consultant the representative is assigned to a consultant in the representative's location, if any, for each specification attributable to that representative's manufacturer. Then, at step 620 the representative is assigned to a bidding and later awarded dealer or originator in the representative's location, if any, for each specification attributable for that representative's manufacturer.

Once these various assignments are made, at step 622 data is generated reflecting the manufacturers, project destination, consultant and dealer(s) associated with a specification for which the representative should receive attribution. At step 624 a member representative is presented with a login screen through which the member representative may access the system to determine the level of attribution assigned. Alternatively, at step 624 a report reflecting attribution is generated and sent to the representative or manufacturer by email or made available for online viewing and archiving. Note that in the context of report generation as described herein or a member representative otherwise requesting attribution or credit status, a member may only retrieve and gain access to information pertaining to that member. As credentials and security settings for a member representative or manufacturer are established, in one embodiment of the specification tracking system, the representative or manufacturer may not view attribution, activities or contract award or specification information unrelated and not associated to the representative or manufacturer.

The specification tracking platform is a dynamic system. In the foodservice industry, there are thousands of potential manufacturer users and thousands of representative users. Over time, new manufacturers and representatives enter the market and are participants in the foodservice operation construction process. As these manufacturers and representatives so participate and become members of the STP, the various profiles, attributes, associations and locations will change. As these condition changes occur, the STP provides a real-time system to ensure that representatives receive full credit for their efforts at every stage of the construction process. Additionally, representatives and manufacturers may use their data to track products in their pipeline to assist with manufacturing schedules and allow manufacturers' representatives to provide metrics to ascertain sales figures in their location or for manufacturers their sales figures in totality.

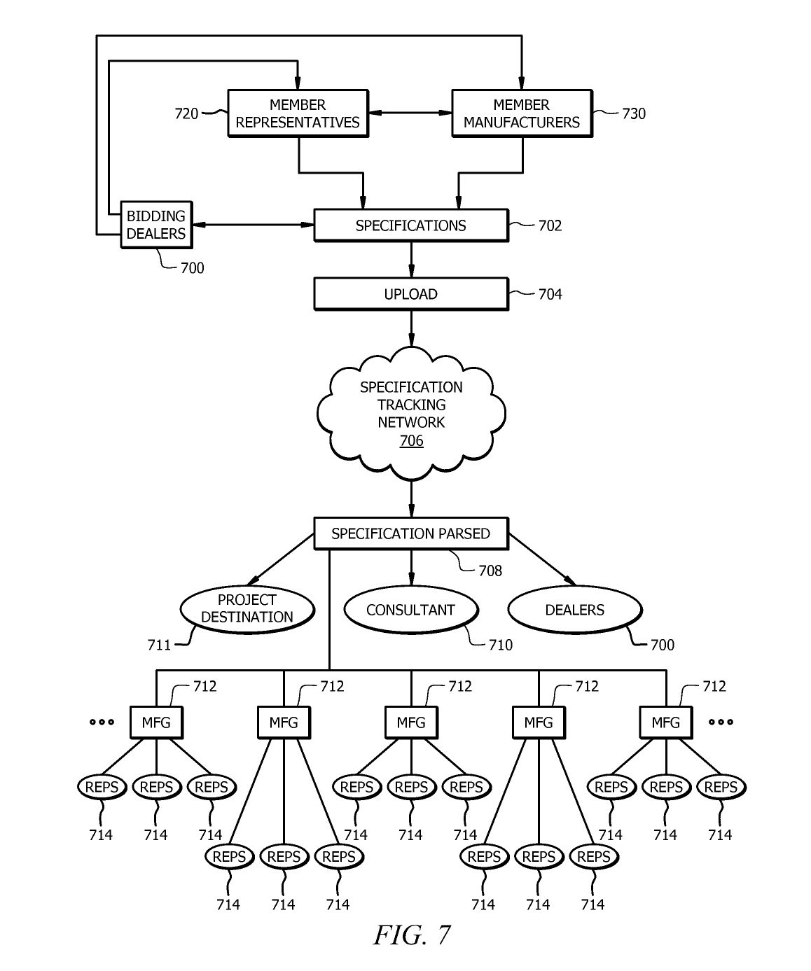

FIG. 7 depicts a schematic and system flow of the processes described in the previous figures. In FIG. 7, member manufacturers' representative 720 and member manufacturer 730 receives a specification from a dealer 700 or from other sources and submits a specification 702 to the specification tracking system 704 via an upload 704 and identifies the bidding dealer 700 performed by a receiving member manufacturers' representative 720 or member manufacturer 730. Once the specification 702 is received by the tracking system 706, it is parsed 708 through use of known parsing techniques and the relevant data from the specification as well as project destination 709, consultant 710 and dealer 700 data is stored in a database. In one embodiment, at a later time once awarded dealer 700 is determined, the project origination will reflect this award as well as continue to store bidding dealer 700 data, in an inactive or non-awarded state as the case may be for a particular specification. The stored data, the operation project participants and information relevant to the representative members and manufacturers is made available to members to efficiently track representative attribution in the new foodservice facility construction process at widespread locations and facilitate prompt and accurate payment of earned commissions and to track manufacturers products sold.

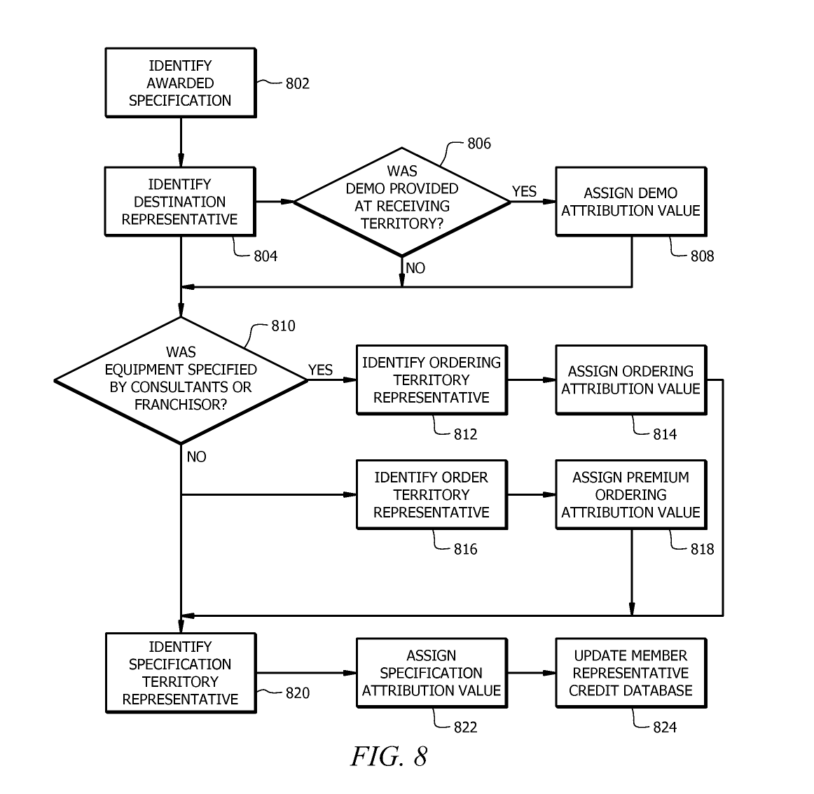

FIG. 8 depicts a flowchart of a credit allocation process of an embodiment of the present system. As discussed, in one embodiment the specification tracking platform includes functionality that allocates attribution to manufacturer representatives who played a role in the specification award and execution of an awarded specification. The specification tracking system associates member representative participation in the specification and fulfillment processes and awards credit to the representatives based on pre-determined criteria. In some contexts, the commission paid to the independent representatives by the manufacturer is divided in three portions between representatives participating at the specification level, the ordering level and the receiving level. With respect to some products, however, demonstration at the receiving location is optional and may not be performed by the representative. In some instances destination location reps provide support for quality and manufacturing issues and also may receive a portion of the total credit/commission for their important contributions that complete the sales process even if a demonstration is not required. As such, the commission assigned by a manufacturer may be divided into two portions rather than three. Similarly, if a design consultant or franchisor does not specify a product, then a higher commission may be awarded to the representative at the ordering location.

Referring to FIG. 8, a process for assigning such commissions by an embodiment of the specification tracking platform begins at step 802 where an awarded specification is identified. At this step, the tracking system begins the process of identifying those awards at the stage at which commission may be awarded. At step 804, the destination representative is identified. At step 806, the system queries whether a demonstration was provided by a representative at the receiving or destination territory. If the answer to this query is yes, then the process proceeds to step 808 in which a demonstration attribution value or commission for the subject awarded specification is assigned to the identified destination representative.

If the answer to query 806 is no, then the system queries at step 810 whether the equipment was specified by a design consultant or franchisor. If the answer to this query is yes, the process proceeds to step 812 where the ordering territory representative is identified. Next, at step 814, an ordering attribution value or commission is assigned to the identified representative.

If on the other hand the answer to query 810 is no, then the process continues at step 816 in which the ordering territory representative is identified. Then, at step 818, a premium ordering attribution value or commission is assigned to the identified representative.

After either step 814 or step 818, the process continues with step 820 with the identification of a specification territory representative for the awarded specification. This is the representative who interfaced with the bidding dealer who was ultimately awarded the project. At step 822, an attribution value or commission is assigned to the specification territory representative. Finally, at step 824 the each identified representative's assigned attribution value is stored in association with the respective member in the credit database.

A manufacturer assigned attribution value is stored in association with the respective member in the credit database.

A manufacturer's defined attribution and commission rates may be pre-established and applied as a rule set to all of its representative. Alternatively, a manufacturer's attribution or commission rates may be a function of number of variables such as product pricing, units sold or other criteria that may be unique to a particular specification. In either case, the manufacturer may log into the specification tracking system and update the credit database according to the desired attribution allocation scenario.

As generally illustrated herein, the system embodiments of the present disclosure can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. The present disclosure includes this type of computer readable media within its scope. The presently disclosed system anticipates a wide variety of variations in the basic theme of construction. The examples presented previously do not represent the entire scope of possible usages. They are meant to cite a few of the almost limitless possibilities. One skilled in the art will recognize that other embodiments are possible based on combinations of elements taught within the above description.

Although a preferred embodiments of the present disclosure have been illustrated in the accompanying drawings and described in the foregoing Detailed Description, it will be understood that the present system is not limited to the embodiments disclosed, but is capable of numerous rearrangements, modifications, and substitutions without departing from the spirit of the system as set forth and defined by the following claims.

### Additional Description

The following clauses are offered as further description of the disclosed invention.

Clause 1. A computer-implemented credit allocation system comprising a networked computing device executing software, further comprising:
a processor configured to receive enrollment information from a prospective member in communication with the processor through a network;
a processor configured to establish a participant account to which is associated a unique identifier in response to received enrollment information;
a processor configured to receive a commercial specification sent from an enrolled member device via a communication network;
a processor configured to employ a character recognition technique to extract data from the commercial specification and assign attributes based on the extracted data according to a geographic location of the participant;
a processor configured to calculate an attribution credit associated with the participant's contribution towards fulfilment of specified commercial endeavors occurring at a plurality of geographic locations; and
a processor configured to report to the participant the level of credit associated with the participant.
Clause 2. The computer-implemented credit allocation system of any proceeding or preceding clause, further comprising:
a processor configured to create a specification attribute file according to information extracted from the specification.
Clause 3. The computer-implemented credit allocation system of any proceeding or preceding clause, wherein the specification attribute file includes the identity of a manufacturer product dealer.
Clause 4. The computer-implemented credit allocation system of any proceeding or preceding clause, wherein the specification attribute file includes the identity of a manufacturer product destination.
Clause 5. The computer-implemented credit allocation system of any proceeding or preceding clause, wherein the specification attribute file includes the identity of a design consultant associated with the manufacturer product.
Clause 6. The computer-implemented credit allocation system of any proceeding or preceding clause, wherein the calculated attribution credit is based on the participant's association with a manufacturer product destination.
Clause 7. The computer-implemented credit allocation system of any proceeding or preceding clause, wherein the calculated attribution credit is based on the participant's association with an originator of the specification.
Clause 8. The computer-implemented credit allocation system of any proceeding or preceding clause, wherein the calculated attribution credit is based on the participant's association with a consultant associated with fulfilment of the specification requirements.
Clause 9. A computer-implemented commercial representative credit allocation system comprising a networked computing device executing software further comprising:
a web browser application;
wherein said web browser application is configured to provide for the receipt of by the commercial representative credit allocation system of a project specification from an enrolled user,
wherein a manufacturer profile is created and updated based on a plurality of manufacturer information extracted from the project specification, and
wherein the profile further includes a hierarchy of the manufacturer's product among a plurality of manufacturer products identified in the project specification.
Clause 10. The computer-implemented commercial representative credit allocation system of any proceeding or preceding clause, further comprising a web browser application configured to provide a user with a graphical user interface through which manufacturer product dealer information may be received by the system, and
further comprising a web browser application configured to provide a user with a graphical user interface through which the destination of the manufacturer product may be received by the system,
wherein said manufacturer product dealer information and said manufacturer product destination information is stored in a database.
Clause 11. The computer-implemented commercial representative credit allocation system of any proceeding or preceding clause, further comprising:
a processor configured to calculate a credit attributable to a manufacturer participant based on the manufacturer product dealer information and the manufacturer product destination information.
Clause 12. The computer implemented commercial representative credit allocation system of any proceeding or preceding clause, further comprising:
a processor configured to retrieve specification information based on an optical characteristic of the specification information.
Clause 13. The computer-implemented commercial representative credit allocation system of any proceeding or preceding clause, further comprising a web browser application configured to provide a user with a graphical user interface through which a request for a status of the commercial representative credit allocation is transmitted.
Clause 14. A method of allocating credit attributable to a participant in fulfilment of a commercial specification, said method at least partially executed on a tangible non-transitory computer usable medium having computer-readable program code means embodied therein for causing a computer to execute one or more steps of said method, the method comprising the steps of: creating, via a web browser operating on a computer system under control of a graphical user interface (GUI) executed with an operating system running under control of said computer system, a manufacturer profile based on information extracted from a commercial project specification, wherein the manufacturer profile includes a manufacturer hierarchy regarding supply of a specified product and information concerning the quantity, type and identifier of a product to be supplied by the manufacturer;
creating, via a web browser operating on a computer system under control of a graphical user interface (GUI) executed with an operating system running under control of said computer system, a participant profile based on manufacturer information received by the participant, including credentials permitting the participant to access specification data pertaining to the manufacturer associated with the participant;
calculating, via said computer system, weighted participant credit attribution values based on relationships designated between the participant and a manufacturer product destination location, between the participant and a specification originator location or between the participant and a manufacturer product order placement location; and
creating, via a web browser operating on a computer system under control of a graphical user interface (GUI) executed with an operating system running under control of said computer system, a participant credit attribution status based on the calculated credit attribution values.
Clause 15. The method of any proceeding or preceding clause, further comprising updating of the participant credit attribution status based on an additional relationship designations.
Clause 16. The method of any proceeding or preceding clause, wherein the information is extracted from the commercial product specification using a textual character recognition technique.

1. A computer-implemented credit allocation system comprising a networked computing device executing software, further comprising:
a processor configured to receive enrollment information from a prospective member in communication with the processor through a network;
a processor configured to establish a participant account to which is associated a unique identifier in response to received enrollment information;
a processor configured to receive and store a commercial specification sent from an enrolled member device via a communication network;
a processor configured to employ a character recognition technique to electronically extract data from the stored commercial specification and assign attributes based on the extracted data according to a geographic location of the participant;
a processor configured to calculate and allocate an attribution credit associated with the participant's contribution towards fulfilment of specified commercial endeavors occurring at a plurality of geographic locations; and
a processor configured to report to the participant the level of credit associated with the participant.

2. The computer-implemented credit allocation system of claim 1, further comprising:
a processor configured to create a specification attribute file according to information extracted from the specification.

3. The computer-implemented credit allocation system of claim 2, wherein the specification attribute file includes the identity of a manufacturer product dealer.

4. The computer-implemented credit allocation system of claim 2, wherein the specification attribute file includes the identity of a manufacturer product destination.

5. The computer-implemented credit allocation system of claim 2, wherein the specification attribute file includes the identity of a design consultant associated with the manufacturer product.

6. The computer-implemented credit allocation system of claim 1, wherein the calculated and allocated attribution credit is based on the participant's association with a manufacturer product destination.

7. The computer-implemented credit allocation system of claim 1, wherein the calculated and allocated attribution credit is based on the participant's association with an originator of the specification.

8. The computer-implemented credit allocation system of claim 1, wherein the calculated and allocated attribution credit is based on the participant's association with a consultant associated with fulfilment of the specification requirements.

9. A computer-implemented commercial representative credit allocation system comprising a networked computing device executing software further comprising:
a web browser application;
wherein said web browser application is configured to provide for the receipt by a commercial representative credit allocation system of a project specification from an enrolled user,
wherein a manufacturer profile is created and updated based on a plurality of manufacturer information extracted from the project specification, and
wherein the profile further includes a hierarchy of the manufacturer's product among a plurality of manufacturer products identified in the project specification.

10. The computer-implemented commercial representative credit allocation system of claim 9, further comprising a web browser application configured to provide a user with a graphical user interface through which manufacturer product dealer information may be received by the system, and
further comprising a web browser application configured to provide a user with a graphical user interface through which the destination of the manufacturer product may be received by the system,
wherein said manufacturer product dealer information and said manufacturer product destination information is stored in a database.

11. The computer-implemented commercial representative credit allocation system of claim 10, further comprising:
a processor configured to calculate and allocate a credit attributable to a manufacturer participant based on the manufacturer product dealer information and the manufacturer product destination information.

12. The computer implemented commercial representative credit allocation system of claim 11, further comprising:
a processor configured to electronically extract specification information based on an optical characteristic of the specification information.

13. The computer-implemented commercial representative credit allocation system of claim 12, further comprising a web browser application configured to provide a user with a graphical user interface through which a request for a status of the commercial representative credit allocation is entered and transmitted.

14. A method of allocating credit attributable to a participant in fulfilment of a commercial specification, said method at least partially executed on a tangible non-transitory computer usable medium having computer-readable program code embodied therein for causing a computer to execute one or more steps of said method, the method comprising the steps of:
creating, via a web browser operating on a computer system under control of a graphical user interface (GUI) executed with an operating system running under control of said computer system, a manufacturer profile based on information electronically extracted from a commercial project specification, wherein the manufacturer profile includes a manufacturer hierarchy regarding supply of a specified product and information concerning the quantity, type and identifier of a product to be supplied by the manufacturer;
creating, via a web browser operating on a computer system under control of a graphical user interface (GUI) executed with an operating system running under control of said computer system, a participant profile based on manufacturer information received by the participant, including credentials permitting the participant to access specification data pertaining to the manufacturer associated with the participant;
calculating, via said computer system, weighted participant credit attribution values based on relationships designated between the participant and a manufacturer product destination location, between the participant and a specification originator location or between the participant and a manufacturer product order placement location; and
creating, via a web browser operating on a computer system under control of a graphical user interface (GUI) executed with an operating system running under control of said computer system, a participant credit attribution status based on the calculated credit attribution values.

15. The method of claim 14, further comprising updating of the participant credit attribution status based on an additional relationship designations.

16. The method of claim 14, wherein the information is electronically extracted from the commercial product specification using a textual character recognition technique.
